(19) United States
(12) Patent Application Publication
(10) Pub. No.: US 2008/0122292 A1
(43) Pub. Date: May 29, 2008

(54) USB cable device, USB subsystem and USB drive devices

(75) Inventor: Akira Minami, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/592,395

(22) Filed: Nov. 3, 2006

(30) Foreign Application Priority Data
Jul. 20, 2006 (JP) 2006-197937

(51) Int. Cl. G06F 1/26; H02J 1/10

(52) U.S. Cl. 307/44

(57) ABSTRACT

The main cable and the drive cable each incorporates a positive power line, a negative power line, a positive signal line and a negative signal line. The main cable is connected to the USB ort of the host apparatus with the connector, and the drive cable is connected to the USB ort of the USB drive device with the connector. In the connector module, the diode is inserted into the positive power line of the auxiliary cable, and the cathode side thereof is connected to the positive power line side of the mutually connected main cable and drive cable.

This application is a priority based on prior application No. JP 2006-197937 filed Jul. 20, 2006, in Japan.

### BACKGROUND OF THE INVENTION

1. Field of the Invention

The present invention relates to a USB cable device, a USB subsystem and USB drive devices. More particularly, the invention relates to a USB cable device, a USB subsystem and USB drive devices for supplying source power necessary for USB drive devices from two USB ports of a higher-level equipment.

2. Description of the Related Art

Conventionally, as an interface for externally connecting various peripheral devices for a personal computer, USBs (Universal Serial Buses) are widely used. A USB can cause operation by supplying power to peripheral devices by having power supply lines in addition to signal lines and can provide an advantage of not requiring a special power supply for peripheral devices. It is thus popularly used because of the convenience of not requiring a special power supply not only for devices of a small power consumption such as a keyboard, a mouse and a memory stick, but also, more recently, for drive devices such as a hard disk drive and an optical disk drive for external connection.

When operating a USB drive device by bus power, a USB port of a personal computer or a PC-card USB hub does not have in some cases a sufficient current supply ability. In such a case, it is the general practice to use an AC adapter by switching over USB's bus power to power supply from an AC system. It is not however desirable to use an AC adapter from the point of view of the weight and the space when considering an environment in which an AC power supply is not applicable and portability.

For the purpose of solving this problem, the following actions are taken for USB devices such as conventional hard disk drives driven by bus power:

### (1) Coping with an instantaneous increase in current by providing a simplified power supply capacity expanding function using a large-capacity capacitor (super-capacitor) for a USB drive device;

### (2) Increasing current by providing two cables with a USB A-connector integrally combined, and connecting, within the cables, a positive power line (Vdd line) and a negative power line (Gnd line), thereby supplying current from two USB ports;

(3) Increasing current by providing two cables with a USB A-connector integrally combined, connecting, within the cables, a positive power line (Vdd line) and a negative power line (Gnd line), inverting a diode into one of the two connected positive power lines, and inserting a fuse into the other, thereby supplying current from two USB ports (Patent Document 1); and
(4) Providing a separate USB cable, in addition to usual USB cables, of which the driving side is connected as a power adapter plug to a power line, supplying power to the drive device from two USB ports, turning on the respective switch circuits in response to the AND output upon detecting power supply from two USB ports within the drive device, and increasing current by combining on the output side of the switch circuit. There are available the following patent documents: JP No. 2005-018717, JP No. 2002-073219, JP No. 2004-054870, JP No. 2005-018716 and JP No. 2005-141732.

However, the conventional technology for filling up the power shortage by a USB suffers from the following problems.

First of all, the technology of providing a power supply capacity expanding function o the simplified type using a super capacitor as a USB drive device requires much time for charging the super capacitor and cannot be applied in a continuous use. Because of the high cost and the large scale in size, it is not commonly applicable.

The technology of providing a cable comprising two integrated cables with an A-connector of USB, connecting a positive power line (Fdd line) and a negative power line (Gnd line) within the cable, and thus supplying current from two USB ports presents a fear that current may flow backward if there is a potential difference between the two USB ports when two cables re simply connected. Backward flow of current forms a violation of Rules of USB.

The technology of inserting a diode into one of the positive power lines of the two USB cable and inserting a fuse into the other is the best solution as compared with the others, but requires considerations on breakage of the fuse.

More specifically, the two cables having a diode and a fuse inserted therein are integrated by a mold or the like, and when using a self-melting fuse, the molten fuse cannot be replaced, resulting in impossibility to use. This would naturally lead to use of a poly-switch or the like which functions as a reusable fuse. A poly-switch has an internal resistance, leading to the problem of an increasing power loss.

In a poly-switch, when an increase in current causes a higher temperature which in turn causes expansion of polymer molecules, and an increase in resistance of carbon having formed a conduction path brings about a high-resistance state, and this limits the flow of current through the circuit. If the factors causing an increase in circuit current are eliminated, a decrease in temperature causes recovery of the original conductivity.

The technology of increasing current by connecting the power lines in the interior by the use of a usual USB cable and a USB cable dedicated to power supply requires a complicated circuit for turning on a switch circuit by means of a logical sum (OR) output by detecting source voltage of the both. When, in the switch-on state, power lines of the two USB cables are directly connected and there is a potential difference between the two USB ports, there occurs a risk of current backward flow, and the backward flow of current forms a violation of the USB Rules.

### SUMMARY OF THE INVENTION

It is an object of the present invention to provide a USB cable device, a USB subsystem and USB drive devices which permit ensuring a power supply necessary for USB devices by use of two USB ports of a host apparatus without causing a violation of the USB Rules or a loss of power.

### (USB Cable Device)

According to the present invention, there is provided a USB cable device. The present invention provides a USB cable device which connects a host apparatus and a USB drive device, comprising:

a main cable incorporating a positive power line, a negative power line, a positive signal line and a negative signal line, and having an end connected to a connector which connects to a first USB port provided in the host apparatus;

an auxiliary cable incorporating a positive power line and connects to a second USB port provided in the host apparatus;

a drive cable incorporating a positive power line, a negative power line, a positive signal line and a negative signal line, and having an end connected to a connector which connects to a USB port provided in a USB drive device; and

a connection module which naturally connects the main cable to the positive power line, the negative power line, a positive signal line and the negative signal line of the drive cable, inserts a diode into the positive power line of the auxiliary cable and connects it thereto, and connects the cathode side of said diode to said main cable and the positive power line of the drive cable.

In the foregoing USB cable device, the connection module has a switch circuit which is turned on at all times in a power supply state from the first port between the positive power line side and the positive power line side of the drive cable connected to the positive power line of the auxiliary cable via the diode.

In the aforementioned USB cable device, the switch circuit which has a p-type MOS-FET, connects the drain of the p-type MOS-FET to the positive power line side of the main cable, connects the source to the positive power line side of the drive cable, and further connects the gate to the side where the negative power line of the main cable and the negative power line of the drive cable are mutually connected.

In another embodiment of the present invention, there is provided a USB cable device, comprising:

a main cable incorporating a positive power line, a negative power line, a positive signal line and a negative signal line, and having an end connected to a connector which connects to a first USB port provided in the host apparatus;

an auxiliary cable incorporating a positive power line and a negative power line, and having an end provided with a connector which connects to a second USB port provided with the host apparatus;

a drive cable incorporating a positive power line, a negative power line, a positive signal line and a negative signal line, and having an end connected to a connector which connects to a USB port provided in a USB drive device; and

a connection module which naturally connects the main cable to the positive power line, the negative power line, the positive signal line and the negative signal line of the drive cable, and provides a switch circuit turned on by detecting power supply from the second port, between the main cable mutually connected to a positive power line of the auxiliary cable and the positive power line side of the drive cable.

In the foregoing USB cable device, the switch circuit comprises:

the main cable which connects the drain thereof to the positive power line side of the auxiliary cable and mutually connects thereto;

a p-type MOS-FET which connects source thereof to the positive power line side of the drive cable; and

a voltage detecting circuit which divides source voltage supplied from the second USB port, and turns on the p-type MOS-FET based on grounding connection of the gate in the p-type MOS-FET by turning on a transistor when the thus divided source voltage exceeds a prescribed threshold voltage.

The connection module has another switch circuit which is turned on at all times in the power supply state from the first port, provided between the positive power line side of the main cable and the positive power line side of the drive cable to which the positive power line of the auxiliary cable is connected via the diode.

Among others, the switch circuit which has a p-type MOS-FET, connects the drain of the p-type MOS-FET to the positive power line side of the main cable, connects the source to the positive power line side of the drive cable, and connects the main cable having mutually connected gates to the negative power line side of the drive cable.

The connector of the main cable and the auxiliary cable is a type A USB connector or a mini-type A USB connector; and the connector of the drive is a type B USB connector or a mini-type B USB connector.

### (USB Subsystem)

According to the present invention, there is provided a USB subsystem. The USB subsystem of the present invention which causes operation by connecting a USB drive device to a USB port of a host apparatus via a cable, comprises:

a main cable which incorporates a positive power line, a negative power line, a positive signal line and a negative signal line, has at an end a first connector connected to a USB port of the host apparatus and a second connector connected to a USB port of the USB drive at the other end;

a power cable which incorporates a positive power line and a negative power line, has a third connector connected to another USB port of the host apparatus at an end thereof and a power connector connected to a power port of the USB port via a diode.

In this subsystem, the first connector of the main cable and the third connector of the power cable are a type A USB connector or a mini-type A USB connectors, and the second connector of the main cable is a type B USB connector or a mini-type B USB connector.

The source connector of the power cable is a DC plug jack.

In another embodiment of the present invention, there is provided a USB subsystem which connects a USB drive device to a USB port of a host apparatus by cable for operation, comprising:

a main cable which incorporates a positive power line, a negative power line, a positive signal line and a negative signal line, has a first connector connecting to a USB port of the host apparatus at an end, and has a second connector connecting to a USB port of the USB drive device at the other end;

a power cable which incorporates a positive power line and a negative power line, has an AC adapter which converts AC power into DC power and outputs the thus converted DC power, provided at an end, and has a power connector connecting to a power port of the USB drive device at the other end; and

a power connecting circuit which connects the positive power line side of the second USB port of the USB drive device to the positive power line side of the first USB port via a diode.

In this embodiment, the first connector of the main cable is a type A USB connector or a mini-type A USB connector, and the second connector of the main cable is a type B USB connector or a mini-type B USB connector. The power connector of the power cable is a DC plug jack.

The present invention provides a USB drive device. The USB drive device of the present invention operating by cable-connecting to a host apparatus, comprising:

a USB port connected to the host apparatus by a main cable which incorporates a positive power line, a negative power line, a positive signal line and a negative signal line;

a power supply port connected to the host apparatus by a power supply cable which incorporates a positive power line and a negative power line; and

a power supply connection circuit which connects the positive power line side of the USB port to the positive power line side of the power supply port via a diode.

In another embodiment of the present invention, the USB drive device operating through cable connection to a host apparatus, comprising:

a USB port connected to the host apparatus by a main cable incorporating a positive power line, a negative power line, a positive signal line and a negative signal line;

a power supply port connected to an AC adapter which converts an AC power into a DC power through a power supply cable incorporating a positive power line and a negative power line and outputs the converted DC power; and

a power supply connecting circuit which connects the positive power line side of the USB port to the positive power line side of the power supply port via a diode.

According to the present invention, as a USB cable device, nothing is inserted into the power line on the main cable side including the signal lines. Diodes are inserted into the power lines on the auxiliary cable side having no signal line, and the cathode side ends of the diodes are connected to the power lines of the main cable. Backward flow of current upon occurrence of a difference in source voltage between the two USB ports is thus prevented. A power loss of the main cable is eliminated and a shortage, if any, is filled up with the auxiliary cable. As a result, the USB device can be easily and reliably operated with bus power from the combination of the two USB ports without the need of a special power supply such as an AC adapter.

By providing a switch circuit based on p-type MOS-FET which is kept on at all times by the supply of source voltage to the power lines of the main cable, it is possibility to inhibit rush current upon cable-connecting the USB drive device and maintain the current balance at a prescribed ratio of the power supplied through the main cable and the auxiliary cable to the USB drive device.

By providing the switch circuit detecting power supply and turning it on in place of the diode inserted on the auxiliary cable side, it is possible to reliably prevent occurrence of a short circuit accident tending to occur by the application of a source voltage onto a connector in an open state of the auxiliary cable when the auxiliary side is separated in a case where only the main cable is connected. There is of course available an inhibiting effect of rush current on the auxiliary cable side upon cable-connecting to the USB drive device.

In the USB subsystem and the USB drive device of the present invention, the USB port of a host apparatus and the USB port on the USB drive device side are connected with the main cable having signal lines. The other USB port of the host apparatus and the power supply port on the USB drive device side are connected with the power cable having no signal line. In the interior of the USB drive device, diodes are inserted into the power lines of the power ports. By connecting the cathode side thereof to the power lines of the USB port, it is possible to minimize the power loss through the main cable and the power cable, and to increase current by supplying bus power from the two USB ports to the USB drive device.

Backward flow caused by a potential difference between the USB ports can be reliably prevented by the diodes incorporated in the USB drive device, thus permitting avoidance of a violation of the USB Rules. Within the USB drive device, only the USB port and the power line of the power port are connected via the diodes. This eliminates the necessity of a complicated circuit operation comprising detecting the source voltage of the two ports, and turning on the switch of the power lines of the individual ports by output of a logical sum, thereby making it possible to ensure cost reduction and reliability improvement.

The above and other objects, features and advantages of the present invention will become more apparent from the following detailed description with reference to the drawings.

### BRIEF DESCRIPTION OF THE DRAWINGS

FIG. 1 is a circuit diagram illustrating an embodiment of the USB cable device of the present invention;

FIG. 2 is a descriptive view illustrating an exterior view of the embodiment shown in FIG. 1;

FIG. 3 is a descriptive view of a state of use of the embodiment shown in FIG. 1;

FIG. 4 is a graph illustrating the relationship between USB port load current and USB port voltage in the embodiment shown in FIG. 1;

FIG. 5 is a circuit diagram illustrating another embodiment of the USB cable device in which a switch circuit is provided on the main cable side;

FIG. 6 is a circuit diagram illustrating still another cable device in which a switch circuit is provided on the auxiliary cable side;

FIG. 7 is a circuit diagram illustrating further another embodiment of the USB cable device in which switch circuits are provided on the main cable side and on the auxiliary cable side;

FIG. 8 is a descriptive view illustrating an embodiment of the USB subsystem of the present invention;

FIG. 9 is an exterior descriptive view of the main cable and the power cable used in the embodiment shown in FIG. 8;

FIGS. 10A and 10B are circuit diagrams of the main cable and the power cable used in the embodiment shown in FIG. 8;

FIG. 11 is a descriptive view illustrating another USB subsystem of the present invention; and

FIGS. 12A, 12B and 12C are circuit diagrams of the main cable and the power cable used in the embodiment shown in FIG. 11.

### DETAILED DESCRIPTION OF THE PREFERRED EMBODIMENTS

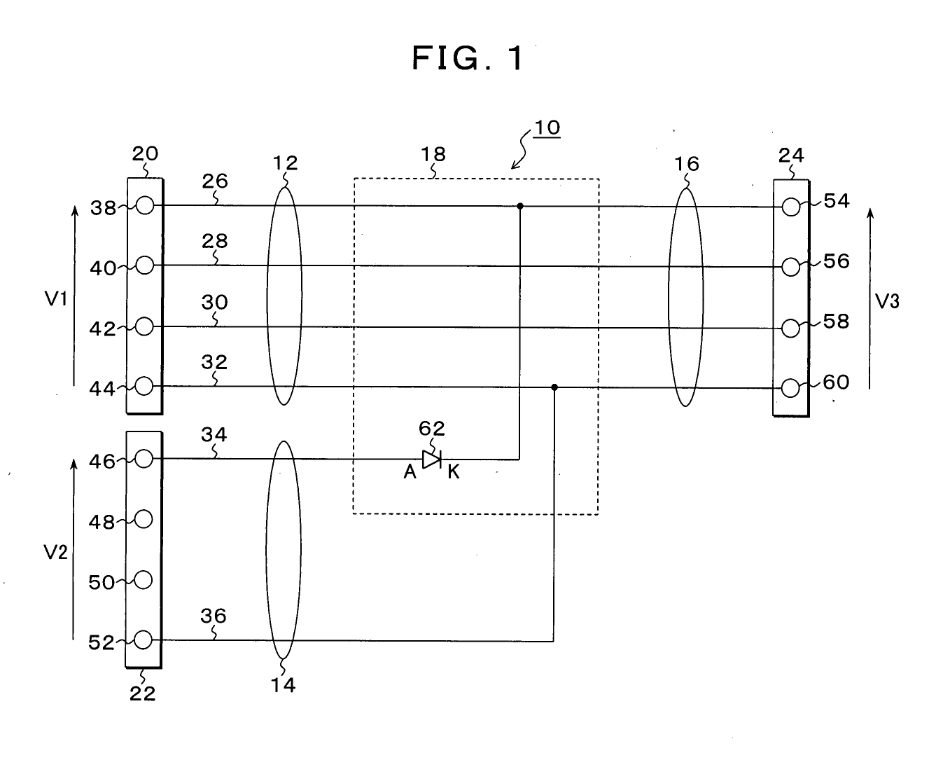

FIG. 1 is a circuit diagram illustrating an embodiment of the USB cable device of the present invention. In FIG. 1, the USB cable device 10 of this embodiment comprises a main cable 12, an auxiliary cable 14, a drive cable 16 and a connection module 18. The main cable 12 has a positive power line (VDD line) 26 prescribed by the USB Rules, a negative power line (GND line) 32 forming a pair therewith, a positive signal line (positive DATA line) 28, and a negative signal line (negative DATA line) 30 forming a pair therewith. The main cable 12 has at an end a connector 20 for connecting to a host USB port of a host such as a personal computer. The connector 20 has a positive power terminal 38, a positive signal terminal 40, a negative signal terminal 42 and a negative power terminal 44. The auxiliary cable 14 has a positive power line 26 and a negative power line 32, but not signal lines corresponding to the positive signal line 28 and the negative signal line 30 of the main cable 12. The auxiliary cable 14 has at an end a connector 22 connecting to another USB port of the host. The connector 22 has a positive power terminal 46, a positive signal terminal 48, a negative signal terminal 50 and a negative power terminal 52. The positive power line 34 is connected to the positive power terminal 46, and the positive signal terminal 48 and the negative signal terminal 50 are vacant terminals. The drive cable 16 has at an end a connector 24 which connects a USB drive device such as a hard disk drive operating by supply of bus power of USB to the USB port. The connector 24 has a positive power terminal 54, a positive signal terminal 56, a negative signal terminal 58 and a negative power terminal 60, which connects the positive power line 26, the positive signal line 28, the negative signal line 30, and the negative power line 32 of the main cable, respectively. The connection module 18 serves to connect the main cable 12, the auxiliary cable 14 and the drive cable 16. In this embodiment, the diode 62 is inserted into the positive power line 34 of the auxiliary cable 14 for connection, and the cathode K side of the diode 62 is connected to the positive power line 26 from the main cable 12. The negative power line 36 of the auxiliary cable 14 is connected directly to the negative power line 32 from the main cable 12. Connection of the signal lines in the connection module 18 and the diode 12 may be accomplished by using a compact printed circuit board, mold-forming it in a state in which the individual signal lines and the diode 62 are connected, and integrating with a cable sheathing, or by removing the sheathing of the connecting portion of the main cable 12, exposing conductors of the positive signal line 26 and the negative signal line 32 contained therein, connecting the positive power line of the auxiliary cable 14 to the exposed conductors via the diode 62, connecting the negative power line 36 directly, and in this state of connection with the mold-formed cable side.

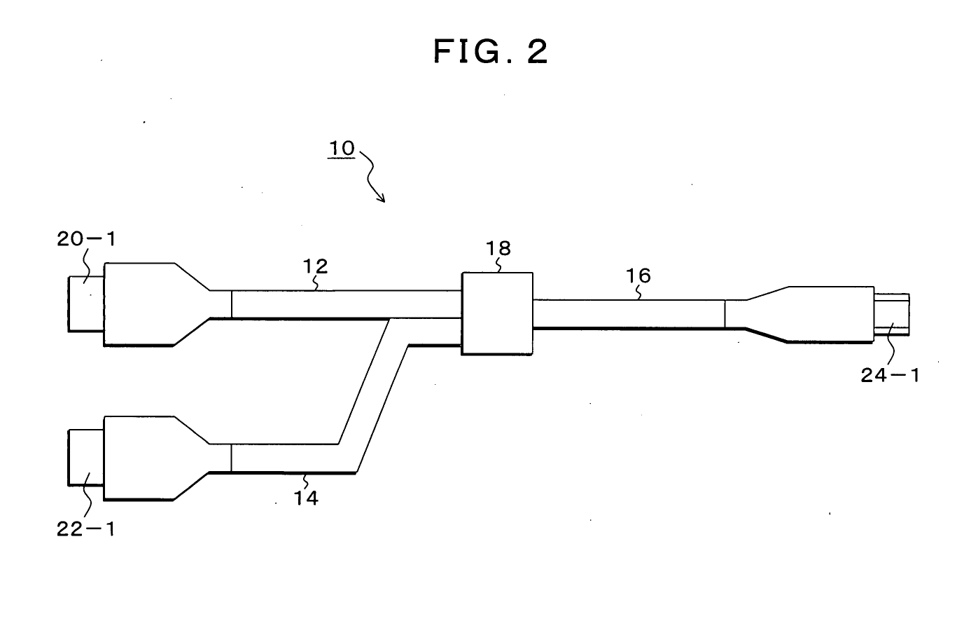

FIG. 2 is a descriptive view illustrating an exterior view of the embodiment of the USB cable device having the circuit configuration shown in FIG. 1, the USB cable device 10 of this embodiment comprises a main cable 12, an auxiliary cable 14, and a drive cable 16, and these cables are comprehensively connected by the connection module 18. A type A USB connector 20-1 is provided at an end of the main cable 12. Similarly, a type B USB connector 24-1 is provided at a leading end of the auxiliary cable 14. At a leading end of the drive cable 14, a type B USB connector 24-1 is provided. In the embodiment shown in FIG. 2, type A USB connectors 20-1 and 22-1 are provided for the main cable 12 and the auxiliary cable 14, and a type B USB connector 24-1 is provided for the drive cable 16. As another embodiment, USB mini-A type connectors may be provided for the main cable 12 and the auxiliary cable 14, and a type B USB connector may be provided for the drive cable 16.

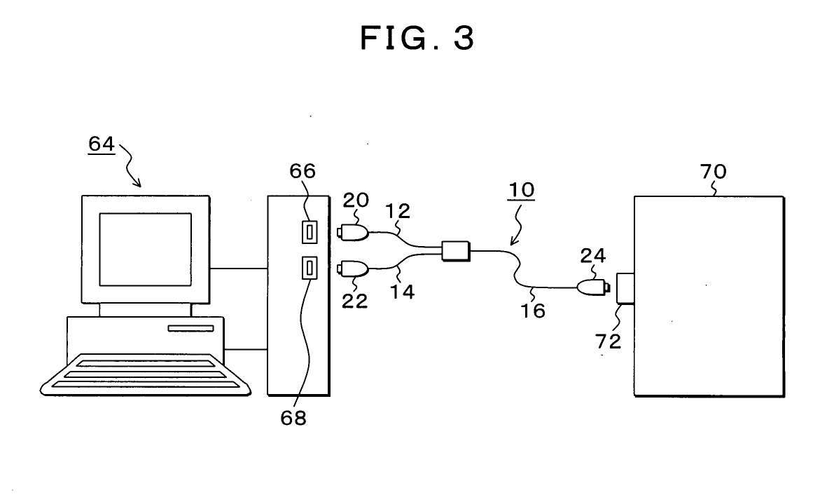

FIG. 3 is a descriptive view of the state of use of the USB cable device 10 provided in the embodiment shown in FIG. 1. In FIG. 3, the personal computer 64 serving as a host has USB ports 66 and 68. The USB cable device 10 of this embodiment is used when connecting a USB drive device 70 as a peripheral device to a personal computer 64. More specifically, the connector 20 of the main cable 12 of the USB cable device 10 is connected to the USB port 66 provided in the personal computer 64. The connector 22 of the auxiliary cable 14 is connected to another USB port 68 provided similarly in the personal computer 64. For the drive cable 16, the connector 24 is connected to a USB; port 72 of the USB drive device 70. If a personal computer 64 connected to this USB cable device of this embodiment is connected to a USB drive device 70, the bus power required for the USB drive device 70 can be supplied as a combination of power supplies from the two USB ports 66 and 68 by connecting the two USB ports 66 and 68 to the USB drive device 70 via the USB cable device 10, even if the bus power from any one of the USB orts 66 and 68 in the personal computer 64 is insufficient. In this connection configuration, the positive power line 34 and the negative power line 36 of the auxiliary cable 14 are connected, via the diode on the positive side, to the positive power line 26 and the negative power line 32 of the main cable 12 as shown in FIG. 1. This combines power supplies from the two USB ports 66 and 68, thus making it possible to supply bus power to the USB drive device 70.

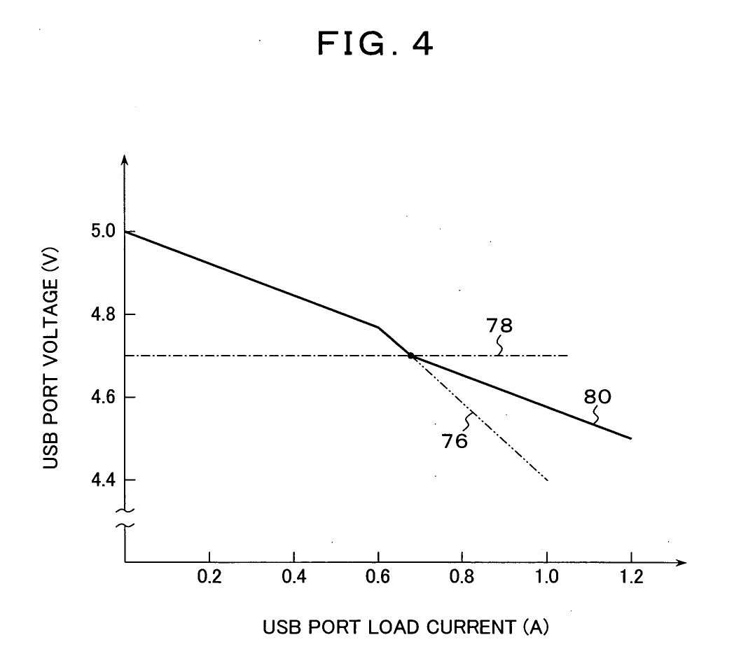

FIG. 4 is a graph illustrating the relationship between the USB port load current and the USB port voltage in the embodiment shown in FIG. 1. In FIG. 4, the abscissa represents the USB port load current, and the ordinate, USB port voltage. The port voltage is 5 V, as specified in the standard. The load current voltage characteristic when using a single USB port is as represented by a load curve 76. In the present embodiment, in contrast, the positive power line 34 and the negative power line 36 of the auxiliary cable 14 are connected to the positive power line 26 and the negative power line 32 of the main cable 12. Connection to the positive power line 34 is accomplished via the diode 62. When the diode-on point level 72 at which the diode 62 inserted into, and connected to, the positive power line 34 side of the auxiliary cable 14 is exceeded, the load curve 76 takes the form as shown by a load curve 80 drawn by a solid line. The load curve 80 thus represents a property to which the current from the auxiliary cable 14 side is added to the load curve 76 based on the main cable 12. Even when the power supply ability from a single USB port, for example, the USB port 66 in the personal computer 64 shown in FIG. 3 is low, it is therefore possible to supply necessary and sufficient drive current to the USB drive device 70 by supplying current from the other USB port 68. In the embodiment shown in FIG. 1, backward flow of current to the USB port 68 connected to the connector 22 of the auxiliary cable 14 from the USB port 66 shown in FIG. 3 which is connected to the connector 20 of the main cable 12 can thus be printed by means of the diode 62, by connecting the anode side of the positive power line 34 of the auxiliary cable 14, via the diode 62, to the positive power line 26 of the main cable 12. More specifically, when the personal computer 64 and the USB drive device 70 are connected as shown in FIG. 3 by use of the USB cable device of the embodiment shown in FIG. 1, there is no resistance component in the positive power line 26 of the main cable 12. For the auxiliary cable 14, in contrast, there exists a resistance component caused by insertion and connection of the diode 62. When the two USB ports connecting the connectors 22 and 24 are assumed to have a port voltage V1 and V2, respectively, in order that the diode 62 is turned on, the voltage of the positive power line 26 on the main cable 12 side should be lower by the voltage effect Vak of the diode 62 in the auxiliary cable 14. As a result, the diode 62 is turned on when the port voltage V1 of the USB port 66 connecting the main cable 12 is lower than the port voltage V2 of the USB port connecting the auxiliary cable 14 by a voltage corresponding to the positive-direction voltage Vak on the diode 62 side. On the contrary, when the port voltage V1 is higher than the port voltage V2, the diode 62 is turned off to prevent backward flow of voltage. When using a USB drive device requiring only a slight driving current, the connector 22 of the auxiliary cable 14 is not used, but the connector 20 of the main cable is used by connecting it to the USB port. The diode 62 is inserted into, and connected to, the power line 34 of the USB cable 14. The connector 22 is therefore in a state in which it is detached, the port voltage applied to the positive power line 26 of the main cable 12 being shut down by the diode 62. Even when the positive power terminal 46 of the connector 22 comes into contact with an article, therefore, flow of short circuit current can be reliably prevented as a result of prevention of backward flow caused by the diode 62.

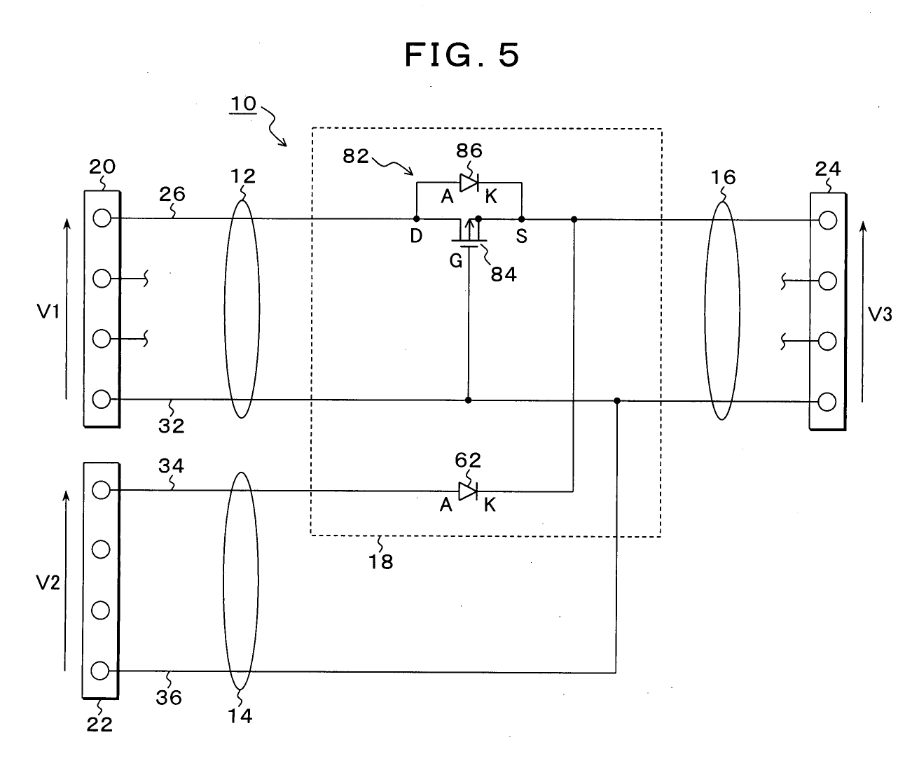

FIG. 5 is a circuit diagram illustrating another embodiment of the USB cable device in which a switch circuit is provided on the main cable side. In FIG. 5, on the auxiliary cable side, the diode 62 inserted into, and connected to, the positive power line 34, as in the embodiment shown in FIG. 1. The negative power line 36 of the auxiliary cable 14 is connected directly to the negative power line of the main cable 12. In this embodiment, a switch circuit 82 is inserted into, and connected to, the positive power line 26 of the main cable 12. The switch circuit 82 has a p-type MOS-FET in which the drain D is connected to the positive power line 26 from the connector 20. The source S is connected to the positive power line side including the drive cable 16 on the connecting point side via the diode 62 of the positive power line 34 of the auxiliary cable 14. The gate G is connected to the negative power line 32. The p-type MOS-FET 84 has a parasitic diode 86 because of its element structure. The parasitic diode 86 is connected in parallel between drain and source with the anode A on the drain side and with the cathode K on the source side. In the embodiment shown in FIG. 5, the switch circuit 82 provided on the main cable 12 side connects the connector 20 to the USB port on the host side. When a port voltage V1 is applied, since the gate G is connected to the negative signal line 32, there occurs a decrease in impedance between the drain and the source upon impression between drain and source of the port voltage V1, causing an on-state at all times. More specifically, when the port voltage V1 is impressed through connection of the connector 20 to the USB port, the p-type MOS-FET 84 is in a high-impedance state immediately after impression of the port voltage, and current flows through the parasitic diode 86 toward the load side. Upon the lapse of a certain period of time from impression of the port voltage V1, the p-type MOS-FET 84 operates, leading to a lower impedance, and the current having so far flowed through the parasitic diode 86 mostly flows from the drain toward the source of the p-type MOS-FET. The switch circuit 82 provided on the main cable 12 side serves to inhibit the rush current flowing toward the load side upon impression of the port voltage V1 after connection of the connector 20 to the USB port and to take current balance between the main cable 12 and the auxiliary cable 14 during operation. As to the prevention of rush current, if there is a capacity component on the USB drive device side connected by the connector 24 of the drive cable 16, a rush current flows to this capacity component upon impression of the port voltage V1 through connection of the connector 20 of the main cable 12 to the USB port. However, a switch circuit 82 is provided for the main cable 12 and the positive power line 26 leading to the drive cable 16. The parasitic diode 86 of the p-type MOS-FET 84 is serially inserted into, and connected to, the positive power line 26, and an on-resistance of the parasitic diode 86 is inserted. Immediately after impression of the port voltage V1, therefore, it is possible to inhibit rush current flowing upon impression of the port voltage onto the USB drive device 70. During operation, on the other hand, the on-resistance of the p-type MOS-FET 84 exists on the main cable 12 side, and the on-resistance of the diode 62 exists on the auxiliary cable 14 side. A current dependent upon the state of these on-resistances therefore flows from the main cable 12 and the auxiliary cable 14 to the USB drive device via the drive cable 16. Since the p-type MOS-FET 84 and the diode 62 have substantially equivalent on-resistances, distribution of USB drive device load current from the drive cable can be balanced about 50 percent between the main cable 12 and the auxiliary cable 14.

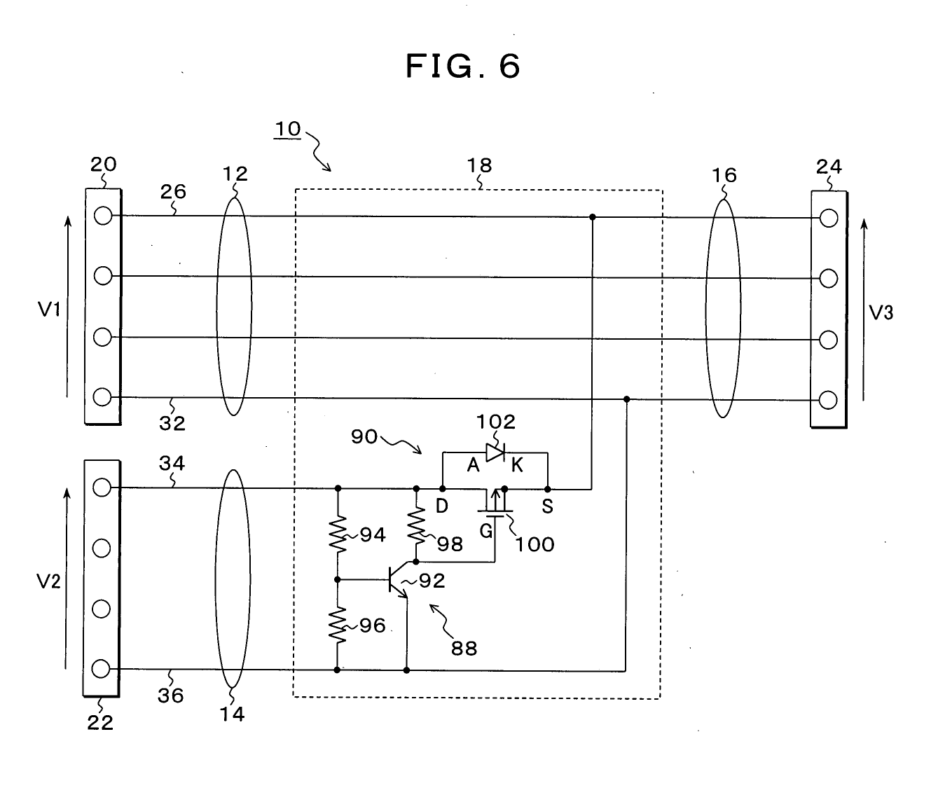

FIG. 6 is another circuit diagram illustrating an embodiment of the USB cable device in which the switch circuit is provided on the auxiliary cable side. In FIG. 6, on the main cable 12 side and the drive cable 16 side, the positive power line 26 and the negative power line 32 are through-connected as they are as in the embodiment shown in FIG. 1. On the auxiliary cable 14 side, however, a switch circuit 90 is provided in place of the diode 62 which has been provided in FIG. 1. The switch circuit 90 is composed of a voltage circuit 88 and a p-type MOS-FET 100. The voltage circuit 88 comprises a transistor 92 and resistances 94, 96 and 98. Port voltage V2 from the USB port on the host side connected to the connector 22 is divided by the resistances 94 and 96 and the divided voltage is impressed onto the base of the transistor 92. The transistor 92 is turned on when the divided voltage of the resistances 94 and 96 becomes higher than a threshold voltage of the transistor. For the MOS-FET 100, the drain D is connected to the positive power line 34 from the connector 22, and the source S is connected to the positive power line 26 of the main cable 12. The negative power line 36 is connected directly to the negative power 34 of the main cable 12. The gate G of the p-type MOS-FET 100 is connected to the connector of the transistor 92, and a parasitic diode 102 is connected in parallel between the drain and the source. In the embodiment shown in FIG. 6, the connector 20 of the main cable 12 and the connector 22 of the auxiliary cable 14 are connected to the two USB ports 66 and 68 provided in the personal computer 64. The connector 24 of the drive cable 16 is connected to the USB port 72 of the USB drive device 70. As a result of this cable connection, a port voltage V1 is impressed onto the connector 20. Another port voltage V2 is impressed onto the connector 22. The port voltage V1 is supplied from the connector 24 of the drive cable 16 to the USB drive device as a load voltage V3 through the positive power line 26 and the negative power line 32 of the main cable 12. Simultaneously with this, the transistor 92 is turned on when the voltage divided by the resistances 92 and 94 exceeds the threshold voltage of the transistor 92 upon impression of the port voltage V2 onto the connector 22. The gate of the p-type MOS-FET 100 is connected to grounding by the negative power line 36, making it possible to turn it on. Current flows from the drive cable 16 to the USB drive device under the effect of the port voltage V1 impressed onto the main cable 12 in this state. When a potential difference from the port voltage V2 of the connector 22 making the p-type MOS-FET 100 operable, corresponding to the diode on-point level 78 shown in FIG. 4 occurs, the p-type MOS-FET 100 is turned on. As shown by the load curve 80 shown in FIG. 4, power is supplied to the USB drive device by adding the current from the auxiliary cable 14 to the current of the main cable 12. In this embodiment shown in FIG. 6 as well, when connection is accomplished without preventing backward flow of current to the USB port of the same host as that using the connector 22 of the auxiliary cable 14 from the USB port connecting the connector 20 of the main cable 12 by providing the switch circuit 90, the port voltage V2 is not impressed. The transistor of the voltage circuit 88 is therefore in the off-state. The p-type MOS-FET 100 is brought into the cutoff-state. It is thus possible to prevent the port voltage V1 of the positive power line 26 of the main cable 12 from being impressed on the connector 22 of the auxiliary cable 14 in the detached state. When some abnormality occurs in the USB port on the host side connected to the connector 22 of the auxiliary cable 14, resulting in a decrease in the port voltage, the divided voltage of the resistances 94 and 96 decreases to below the threshold voltage of the transistor 92 as a result of the decrease in the port voltage V2. This turns off the transistor 97 and cuts off the p-type MOS-FET 100. It is thus possible to prevent backward flow of current caused by the port voltage V1 relative to the connector 20 of the main cable 12 operating normally against the decrease in port voltage V2.

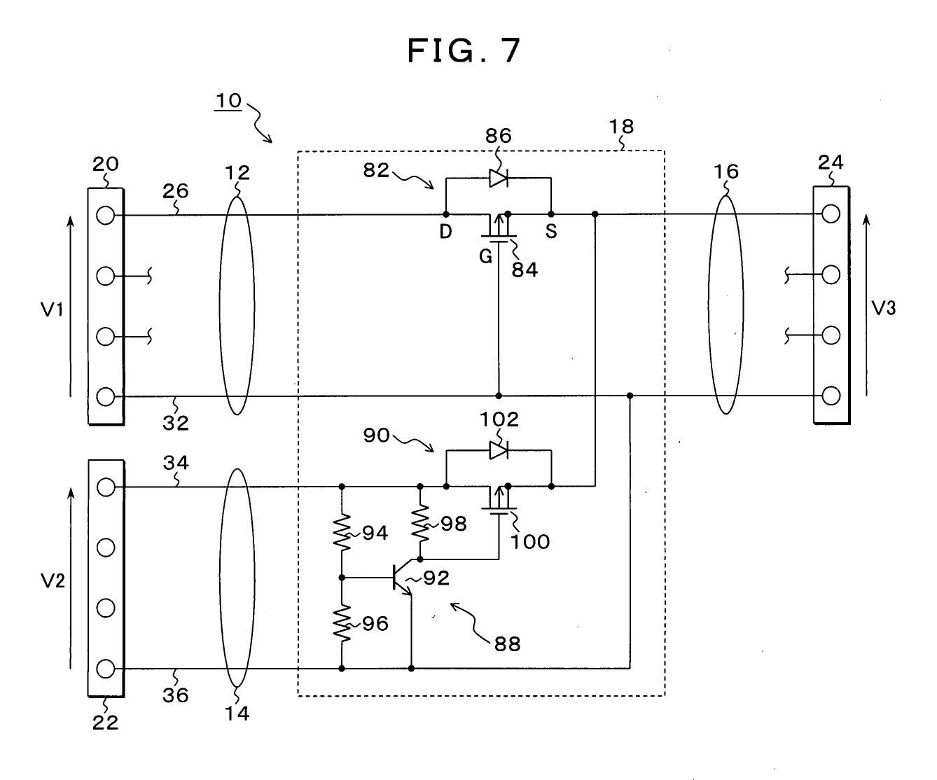

FIG. 7 is a circuit diagram illustrating another embodiment of the USB cable having switch circuits on the main cable side and on the auxiliary cable side. In the embodiment shown in FIG. 7, the main cable 12 side in the embodiment of FIG. 5 and the auxiliary cable 14 side in the embodiment of FIG. 6 are combined. A switch circuit 82 using a p-type MOS-FET 84 is provided on the main cable 12 side, and the same switch circuit 90 as in FIG. 6 is provided on the auxiliary cable 14 side. The switch circuit 90 has a voltage detecting circuit 88 using a transistor 92 and a p-type MOS-FET 100. In the embodiment shown in FIG. 7, rush current is prevented by the switch circuit 82 of the main cable 12. Backward flow of current to the USB port on the auxiliary cable 14 side from the main cable 12 side can be prevented by the switch circuit 90 on the auxiliary cable 14 side. A switch circuit 82 is provided on the main cable 12 side, and another switch circuit 90 is provided on the auxiliary cable 14 side. This enables to take balance of current through on-resistance of the switch circuits 82 and 90, respectively.

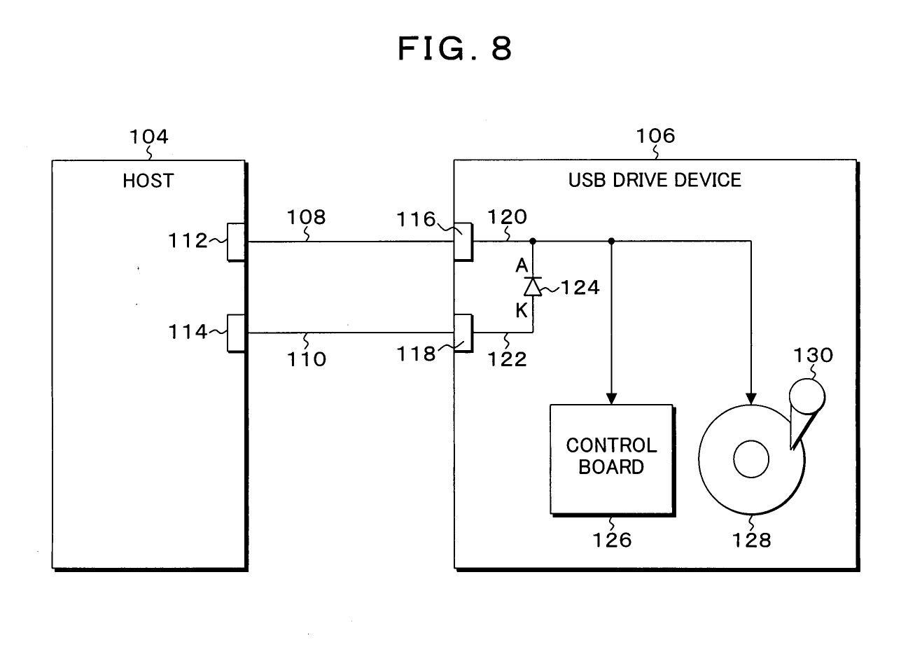

FIG. 8 is a descriptive view illustrating an embodiment of the USB subsystem of the present invention. The embodiment shown in FIG. 8 covers a case where a USB drive 106 is connected as a peripheral device to a host 104 as a personal computer. From among two USB ports 112 and 114 provided in the host 104, the USB port 112 is connected to a USB port 116 of the USB drive device 106 by use of the main cable 108 to ensure signal transmission simultaneously with power supply. The other USB port 114 of the host 104 and a power supply port 118 provided in a USB drive device 106 are connected to each other by means of a power supply cable 110. As described more clearly later, the power supply cable 110 includes only a positive power line and a negative power line. The positive power live 120 side is drawn out from the power supply port 108 in the USB drive device 106. A diode 124 is inserted therein and connected thereto. The cathode K side thereof is connected to the positive power line 122 side drawn out from the USB port 116. The positive power line 120 from the USB port 116 and the positive power line from the power supply port 118 are connected via the diode 124, and then, supply power to a control board 26 serving as a controlling circuit unit incorporated in the USB drive device 106, a spindle motor (not shown) rotation-driving a disk medium 128, and a voice coil motor driving a head actuator 130.

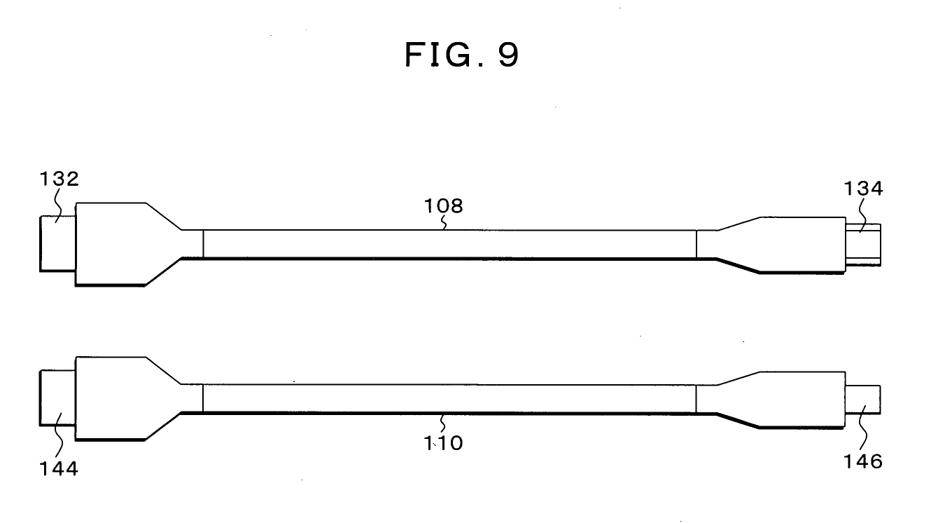

FIG. 9 is a descriptive view of the exterior view of the main cable and the power cable used in the embodiment shown in FIG. 8. In FIG. 9, a main cable 108 has a type A USB connector 132 at an end thereof, and a type B connector 134 at the other end. A power cable 110 has a type A USB connector 144 at an end thereof and a special power connector 146 at the other end.

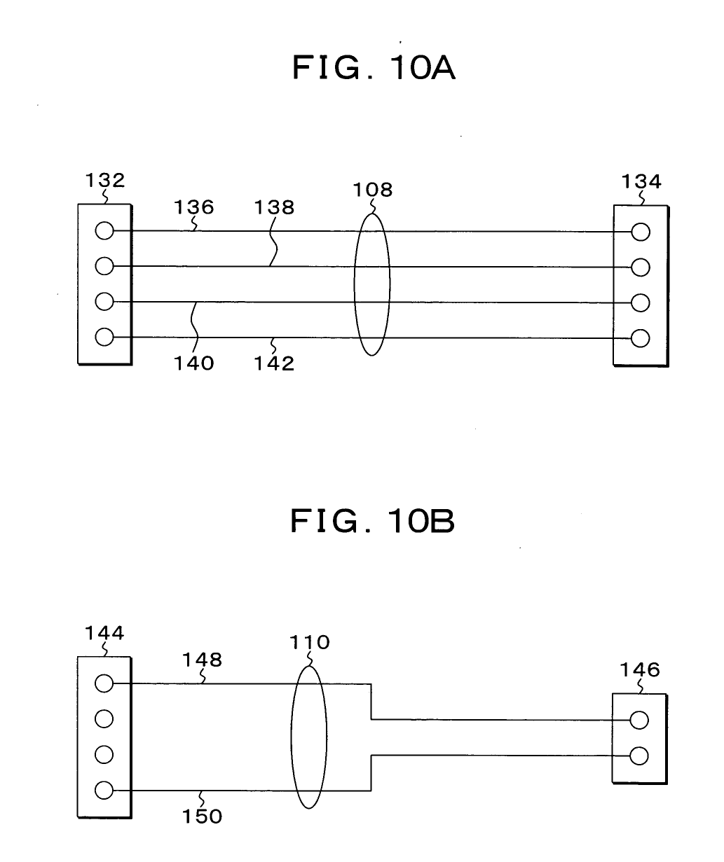

FIGS. 10A and 10B are circuit diagrams of the main cable and the power cable used in the embodiment shown in FIG. 8. In the main cable 108 shown in FIG. 10A, a type A USB connector 132 connected to a USB port on the host side has four terminals including a positive and a negative power terminals and a positive and a negative signal terminals, each drawing out a positive power line 136, a positive signal line 138, a negative signal line 140 and a negative power line 142, connected to a type B USB connector 134 connected to the USB drive device side. On the other hand, the power cable 110 illustrated in FIG. 10B uses a positive power terminal and a negative power terminal of a type A USB connector 144, drawing out, respectively, a positive power line 148 and a negative power line 150, connected to a power supply connector 146 on the USB drive device side. In the USB subsystem of FIG. 8 which connects the host 104 and the USB drive device 106 by use of these main cable 108 and the power cable 110, if current from a single USB port is insufficient for the USB drive device 106, connection through the power cable 110 is conducted in addition to the connection through the main cable 108. The positive power line 122 side of the power cable 110 is connected, via a diode 124, to the positive power line 120 side of the main cable 108 within the USB drive device 106. Current from the two USB ports 112 and 114 is combined within the USB drive device 106 to supply power to load such as a control board 126 and a disk medium 128. As a result, even when supplying current from the two USB ports 112 and 114 to the USB drive device 106, backward flow of current from the USB port 112 to the USB port 114 can be reliably prevented by the diode 124. The dividing current can be increased only by means of a simple circuit configuration of connecting a power line, via the diode 124, to the other power line in the USB drive device 106 for current supplied from the two USB ports 112 and 114. The main cable 108 and the power cable 110 are provided for connecting the host 104 and the USB drive device 106. The main cable 108 is originally provided for connecting the USB orts 112 and 114 to each other in a usual configuration. In the present embodiment, therefore, the only thing to do is to add the power cable 110. Because of this advantage, the cable cost can be considerably reduced as compared with the use of a USB cable device integrating by combining a main cable 12, an auxiliary cable 14 and a drive cable 16 by a connection module 18 as in the embodiments shown in FIGS. 1 to 7.

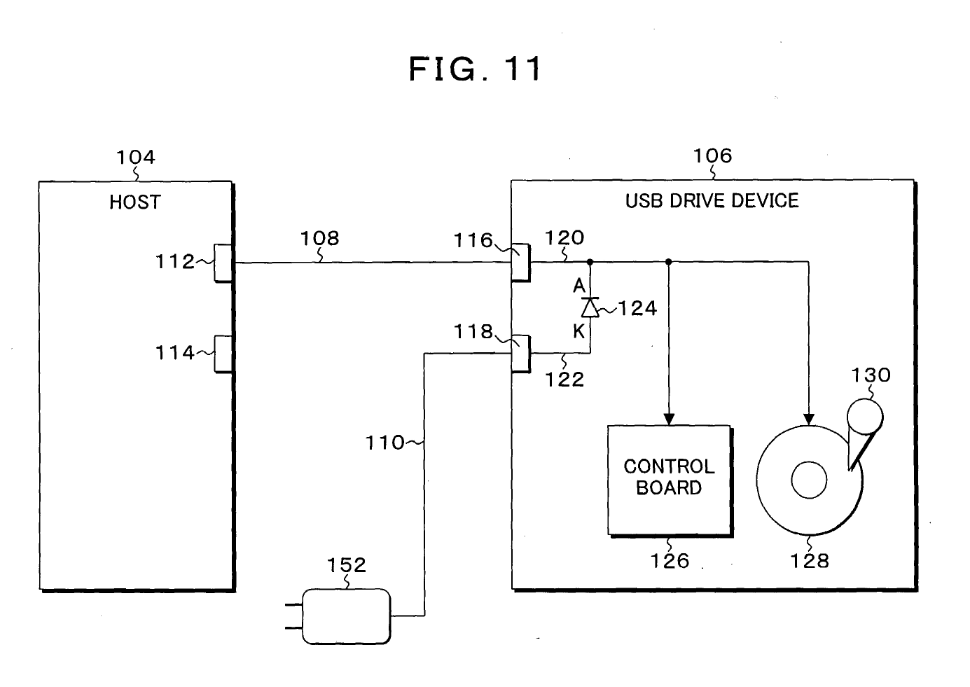

FIG. 11 is a descriptive view illustrating another embodiment of the USB subsystem of the present invention. In the embodiment of the USB subsystem shown in FIG. 11, a USB port 116 and a power supply port 118 re provided on the USB drive device 106 side. The circuit configuration in which the positive power line 122 on the power supply ort 118 side is connected, via the diode 124, to the anode side of the positive power line 122 from the USB ort 116 is the same as in the embodiment shown in FIG. 8. This circuit configuration shown in FIG. 11 is, in contrast, characterized in that an AC adapter 152 is connected to the power supply port 118 through the power cable 110. The main cable 108 is totally identical with that in FIG. 8.

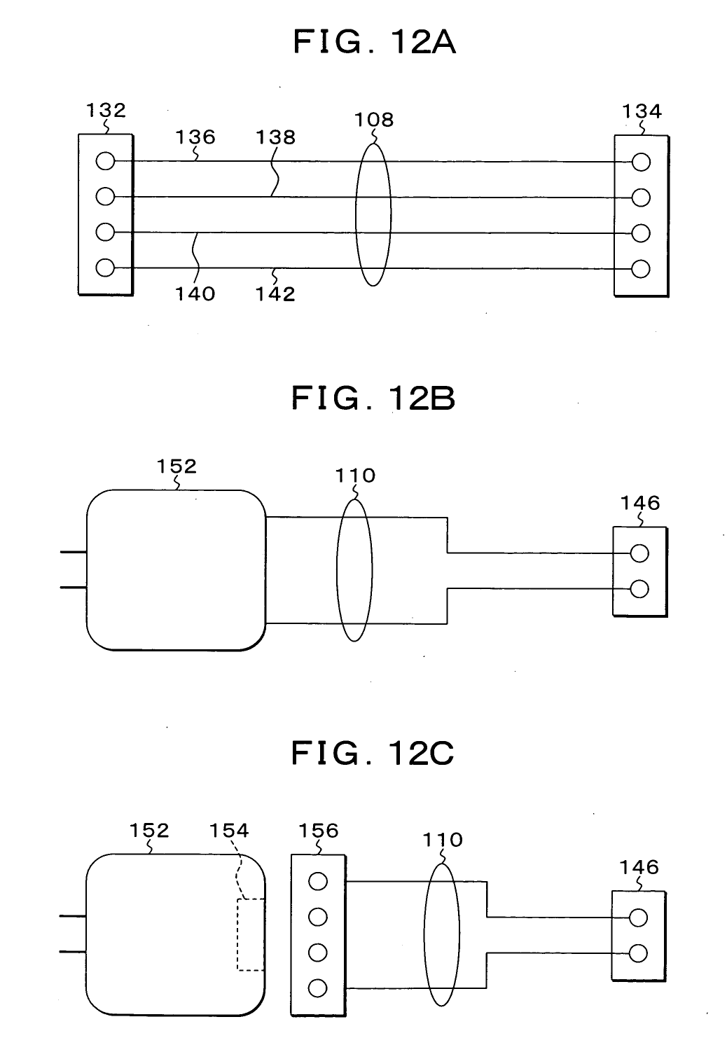

FIGS. 12A, 12B and 12C are circuit diagrams of the main cable and the power supply cable used in the embodiment shown in FIG. 11. The main cable 108 in FIG. 12A is the same as in FIG. 10A. The power supply cable 110 shown in FIG. 12B is different in that it has an AC adapter 152. The AC adapter 152 has only to have a current supply ability corresponding to the USB port, leading to only a limited power supply and the circuit configuration is low is cost. FIG. 12C illustrates the configuration of another power cable. In this example, a type A USB connector 156 is connected to the power cable 110. This is applicable by connected-connecting to the USB port 154 of the AC adapter 152. For the USB systems shown in FIGS. 8 and 11, another embodiment of the present invention provides the USB drive device 106 itself. This USB drive device 106 is characterized in that it has a USB port 116 and a power supply port 118; the cathode K side of the positive power line 122 from the power port 118 is connected, via the diode 124, the positive power line 120 from the USB port 116; and current from the two power lines 120 and 122 can be supplied to the load by combining.

The present invention includes appropriate variations not impairing the objects and advantages, and is not limited by numerical values shown in the aforementioned embodiments.

What is claimed is:

1. A USB cable device which connects a host apparatus and a USB drive device, comprising:
a main cable incorporating a positive power line, a negative power line, a positive signal line and a negative signal line, and having an end connected to a connector which connects to a first USB port provided in the host apparatus;
an auxiliary cable incorporating a positive power line and a negative power line, and having an end provided with a connector which connects to a second USB port provided in the host apparatus;
a drive cable incorporating a positive power line, a negative power line, a positive signal line and a negative signal line, and having an end connected to a connector which connects to a USB port provided in a USB drive device; and
a connection module which naturally connects the main cable to the positive power line, the negative power line, a positive signal line and the negative signal line of the drive cable, inserts a diode into the positive power line of the auxiliary cable and connects it thereto, and connects the cathode side of said diode to said main cable and the positive power line of the drive cable.

2. The USB cable device according to claim 1, wherein said connection module has a switch circuit which is turned on at all times in a power supply state from said first port between the positive power line side and the positive power line side of said drive cable connected to the positive power line of said auxiliary cable via said diode.

3. The USB cable device according to claim 1, wherein said switch circuit which has a p-type MOS-FET, connects a drain of said p-type MOS-FET to the positive power line side of said main cable, connects the source to the positive power line side of said drive cable, and further connects the gate to the side where the negative power line of said main cable and the negative power line of the drive cable are mutually connected.

4. A USB cable device which connects a host apparatus and a USB drive device, comprising:
a main cable incorporating a positive power line, a negative power line, a positive signal line and a negative signal line, and having an end connected to a connector which connects to a first USB port provided in the host apparatus;
an auxiliary cable incorporating a positive power line and a negative power line, and having an end provided with a connector which connects to a second USB port provided with the host apparatus;
a drive cable incorporating a positive power line, a negative power line, a positive signal line and a negative signal line, and having an end connected to a connector which connects to a USB port provided in a USB drive device; and
a connection module which naturally connects the main cable to the positive power line, the negative power line, the positive signal line and the negative signal line of the drive cable, and provides a switch circuit turned on by detecting power supply from said second port, between said main cable mutually connected to a positive power line of said auxiliary cable and the positive power line side of said drive cable.

5. The USB cable device according to claim 1, wherein said switch circuit comprises:
said main cable which connects the drain thereof to the positive power line side of said auxiliary cable and mutually connects thereto;
a p-type MOS-FET which connects source thereof to the positive power line side of said drive cable; and
a voltage detecting circuit which divides source voltage supplied from said second USB port, and turns on said p-type NIS-FET based on grounding connection of the gate in said p-type MOS-FET by turning on a transistor when the thus divided source voltage exceeds a prescribed threshold voltage.

6. The USB cable device according to claim 1, wherein said connection module has another switch circuit which is turned on at all times in the power supply state from said first port, provided between the positive power line side of said main cable and the positive power line side of said drive cable to which the positive power line of said auxiliary cable is connected via said diode.

7. The USB cable device according to claim 1, wherein said switch circuit which has a p-type MOS-FET, connects the drain of said p-type MOS-FET to the positive power line side of said main cable, connects the source to the positive power line side of said drive cable, and connects said main cable having mutually connected gates to the negative power line side of the drive cable.

8. The USB cable device according to claim 1, wherein the connector of said main cable and the auxiliary cable is a type A USB connector or a mini-type A USB connector; and the connector of said drive is a type B USB connector or a mini-type B USB connector.

9. A USB subsystem which causes operation by connecting a USB drive device to a USB port of a host apparatus via a cable, comprising:
a main cable which incorporates a positive power line, a negative power line, a positive signal line and a negative signal line, has at an end a first connector connected to a USB port of said host apparatus and a second connector connected to a USB port of said USB drive device at the other end;
a power cable which incorporates a positive power line and a negative power line, has a third connector connected to another USB port of said host apparatus at an end thereof and a power connector connected to a power port of said USB drive device at the other end thereof; and
a power supply connecting circuit which connects the positive power line side of the USB port of said USB drive device to the positive power line side of said power supply port via a diode.

10. The USB subsystem according to claim 9, wherein the first connector of said main cable and the third connector of said power cable are a type A USB connector or a mini-type A USB connectors, and the second connector of said main cable is a type B USB connector or a mini-type B USB connector.

11. The USB subsystem according to claim 10, wherein the source connector of said power cable is a DC plug jack.

12. A USB subsystem which connects a USB drive device to a USB port of a host apparatus by cable for operation, comprising:
a main cable which incorporates a positive power line, a negative power line, a positive signal line and a negative signal line, has a first connector connecting to a USB port of said host apparatus at an end, and has a second connector connecting to a USB port of said USB drive device at the other end;
a power cable which incorporates a positive power line and a negative power line, has an AC adapter which converts AC power into DC power and outputs the thus converted DC power, provided at an end, and has a power connector connecting to a power port of said USB drive device at the other end; and
a power connecting circuit which connects the positive power line side of the second USB port of said USB drive device to the positive power line side of said first USB port via a diode.

13. The USB subsystem according to claim 12, wherein the first connector of said main cable is a type A USB connector or a mini-type A USB connector, and the second connector of said main cable is a type B USB connector or a mini-type B USB connector.

14. The USB subsystem according to claim 13, wherein the power connector of said power cable is a DC plug jack.

15. A USB drive device operating by cable-connecting to a host apparatus, comprising:
a USB port connected to said host apparatus by a main cable which incorporates a positive power line, a negative power line, a positive signal line and a negative signal line;
a power supply port connected to said host apparatus by a power supply cable which incorporates a positive power line and a negative power line; and
a power supply connection circuit which connects the positive power line side of said USB port to the positive power line side of said power supply port via a diode.

16. A USB drive device operating through cable connection to a host apparatus, comprising:
a USB port connected to said host apparatus by a main cable incorporating a positive power line, a negative power line, a positive signal line and a negative signal line;
a power supply port connected to an AC adapter which converts an AC power into a DC power through a power supply cable incorporating a positive power line and a negative power line and outputs the converted DC power; and
a power supply connecting circuit which connects the positive power line side of said USB port to the positive power line side of said power supply port via a diode.

17. The USB cable device according to claim 3, wherein the connector of said main cable and the auxiliary cable is a type A USB connector or a mini-type A USB connector; and the connector of said drive is a type B USB connector or a mini-type B USB connector.
